(19) United States
(12) Patent Application Publication
(10) Pub. No.: US 2019/0121709 A1
(43) Pub. Date: Apr. 25, 2019

(54) DISTRIBUTED EXTENT BASED REPLICATION

(71) Applicant: HEWLETT PACKARD ENTERPRISE DEVELOPMENT LP, Houston, TX (US)

(72) Inventors: Ayman ABOUELWAFA, Folsom, CA (US); Douglas L. VOIGT, Boise, ID (US); Alex VEPRINSKY, Fremont, CA (US)

(73) Assignee: HEWLETT PACKARD ENTERPRISE DEVELOPMENT LP, Houston, TX (US)

(21) Appl. No.: 15/793,916

(22) Filed: Oct. 25, 2017

(51) Int. Cl. G06F 11/20; G06F 3/06; G06F 11/14

(52) U.S. Cl. CPC G06F 11/2056; G06F 17/30581; G06F 11/1446; G06F 3/065

(57) ABSTRACT

In some examples, with respect to distributed extent based replication, a plurality of logical unit number (LUN) extents may be ascertained for a local storage array including a LUN. A LUN owner may be assigned to the LUN. Respective access patterns used to access each of the plurality of LUN extents may be analyzed. Based on the analyzed access patterns, respective replication owners may be determined for each of the plurality of LUN extents independent of the LUN owner assigned to the LUN.

### BACKGROUND

A data storage system may include a plurality of data storage volumes. Data in a data storage volume may be replicated to another data storage volume. Replication may include the frequent electronic copying of the data between different data storage volumes so that users that access the different data storage volumes have the same information available in each data storage volume. Moreover, with respect to failure associated with a data storage volume, the data may be retrieved from another replicated data storage volume to prevent data loss.

### BRIEF DESCRIPTION OF DRAWINGS

Features of the present disclosure are illustrated by way of example and not limited in the following figure(s), in which like numerals indicate like elements, in which:

FIG. 1 illustrates an example layout of a distributed extent based replication apparatus;

FIG. 2 illustrates unidirectional logical unit number (LUN) access to illustrate operation of the distributed extent based replication apparatus of FIG. 1;

FIG. 3 illustrates example bidirectional LUN access with smart proxy to illustrate operation of the distributed extent based replication apparatus of FIG. 1;

FIG. 4 illustrates an example LUN including a plurality of LUN extents to illustrate operation of the distributed extent based replication apparatus of FIG. 1;

FIG. 5 illustrates example bidirectional LUN access for a fully replicated LUN to illustrate operation of the distributed extent based replication apparatus of FIG. 1;

FIG. 6 illustrates example bidirectional LUN access replication to illustrate operation of the distributed extent based replication apparatus of FIG. 1;

FIG. 7 illustrates an example block diagram for distributed extent based replication;

FIG. 8 illustrates an example flowchart of a method for distributed extent based replication; and

FIG. 9 illustrates a further example block diagram for distributed extent based replication.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Apparatuses for distributed extent based replication, methods for distributed extent based replication, and non-transitory computer readable media having stored thereon machine readable instructions to provide distributed extent based replication are disclosed herein.

With respect to data replication, storage arrays may host data that is used in a block format and/or files for local hosting or cloud use. In this regard, data replication may be described as a frequent electronic copying of the data from one logical unit number (LUN) to another LUN, or to a group of LUNs. The data replication may be performed based on rules that may be implemented to copy the data from one LUN to another LUN, or to a group of LUNs. Examples of types of data replication may include synchronous replication, asynchronous replication, active-active replication, etc., as disclosed herein.

A storage array (or array) may be described as a device that includes a data storage device. The storage array may further include controls for input/output of data to the data storage device. An example of a storage array may include a redundant array of independent disks, etc.

A LUN may be described as a logical storage volume of a storage array. The LUN may be addressable to a host associated with the storage array.

A host may be described as a device that sends input/output requests (e.g., read/write requests) to a storage array. A host may include a physical device such as a computer, or a virtual device.

A storage array may present and provide for replication of data in a LUN or a LUN group format. Although data hosted by storage arrays may be stored in a LUN or a LUN group format, a host application may depend on data sets as opposed to LUNs, independently of the entities hosting the data sets. Examples of data sets may include data-base-tables of a data base, files, and/or directories of a file-share. Since replication may be based on LUNs, data that is not accessed by such applications and does not need to be replicated may still be replicated. This results in wastage of space, central processing unit (CPU) cycles, replication link efficiency, and bandwidth. In this regard, it is technically challenging to control LUN replication to reduce such wastage of space, CPU cycles, replication link efficiency, and bandwidth.

In order to address, for example, at least the aforementioned technical challenges, the apparatuses, methods, and non-transitory computer readable media disclosed herein may implement an extent based replication that may decouple the array based replication from the LUNs/LUN group. The apparatuses, methods, and non-transitory computer readable media disclosed herein may instead associate the replication to a granular and smaller object, or group of objects denoted extents (or LUN extents).

A LUN extent may be described as a range of contiguous logical block addresses (LBAs) in a given LUN, and may be considered the smallest manageable and trackable replication unit/object within a LUN. A LUN extent may also be as large as the entire LUN if needed, which may thus provide for replication on a per LUN basis.

As disclosed herein, a LUN extent may be assigned and reassigned a replication owner dynamically among different arrays to correlate the extent access to the hosts, and then drive the extent replication direction accordingly for optimum performance. Thus, instead of the need to replicate an entire LUN, the apparatuses, methods, and non-transitory computer readable media disclosed herein may provide for replication of LUN extents, and may further provide for control of the replication direction.

With respect to control of replication ownership, the apparatuses, methods, and non-transitory computer readable media disclosed herein may provide for control of the replication ownership from within a storage array. Alternatively or additionally, the apparatuses, methods, and non-transitory computer readable media disclosed herein may provide for control of the replication ownership from a source that is external to a storage array and controls the replication direction.

With respect to replication ownership, the apparatuses, methods, and non-transitory computer readable media disclosed herein may provide for control of the replication ownership by either host access where a storage array may detect access rates to self-tune replication ownership to optimize performance. Alternatively, the replication ownership may be decided by an external source to optimize functionality.

With respect to replication ownership, the extent based replication as disclosed herein may be scaled from two to a comparably large number of storage arrays. For example, a LUN extent may be replicated from one storage array to a plurality of storage arrays, while the replication ownership may move from one storage array to another. Further, the replication direction may follow the replication ownership determination as disclosed herein, and may be between one LUN extent to another LUN extent, or between one LUN extent to many LUN extents.

According to examples, the apparatuses, methods, and non-transitory computer readable media disclosed herein may provide for extent based replication with a capability to replicate sub-LUN portions (e.g., a LUN extent or a plurality of LUN extents) that may be mapped to application-level objects. For example, the extent based replication as disclosed herein may provide for integration with an array data filer that offers file service to enable a host to request local/remote replication on a per file or a per directory basis, instead of replication based on an entire LUN. The extent based replication as disclosed herein may provide for a database plugin to request local/remote replication, and/or selection of providers on a per record/table basis, instead of for an entire LUN. The extent based replication as disclosed herein may provide for requesting of local/remote replication or migration of a given cloud object. The extent based replication as disclosed herein may provide for control of a virtual machine/remote replication, migration, and virtual machine performance tuning.

According to examples, with respect to a LUN active-active replication with smart-proxy as disclosed herein, the apparatuses, methods, and non-transitory computer readable media disclosed herein may provide for distributed replication ownership instead of a per LUN ownership where active-active storage arrays may self-tune replication ownership based on host access, and are independent from the replication direction.

According to examples, the apparatuses, methods, and non-transitory computer readable media disclosed herein may provide a host application greater flexibility and control over replication, as replication of an entire LUN is no longer needed (where a LUN may house multiple applications). Instead, the replication may be limited to what is needed by the application.

According to examples, the apparatuses, methods, and non-transitory computer readable media disclosed herein may provide for mapping of a LUN extent (or a plurality of LUN extents) to different replication owners. The mapping may be used to initiate (local/remote) file-based replication.

According to examples, the apparatuses, methods, and non-transitory computer readable media disclosed herein may provide for replication control where a storage array agent, for example, may allow a host application to locally or remotely request replication.

According to examples, the apparatuses, methods, and non-transitory computer readable media disclosed herein may provide for use of remote copy technologies by offering active-active replication through bidirectional access as disclosed herein.

According to examples, the apparatuses, methods, and non-transitory computer readable media disclosed herein may provide for self-tuning of a storage array based on workload increases or decreases of an associated host.

According to examples, the apparatuses, methods, and non-transitory computer readable media disclosed herein may provide an indicator of array performance based on correlation of host-workload to array-performance, to thus provide predictability with respect to storage array performance.

According to examples, the apparatuses, methods, and non-transitory computer readable media disclosed herein may provide for load balanced replication, where a plurality of different replication owners may facilitate load balancing.

According to examples, the apparatuses, methods, and non-transitory computer readable media disclosed herein may provide an indexed extent access pattern for a LUN. For example, the indexed extent access pattern as disclosed herein may be used to enable a transfer of the access pattern from one storage array to another storage array in the event of a shift in a workload, or a user decision to execute an application in a different location, etc.

For the apparatuses, methods, and non-transitory computer readable media disclosed herein, modules, as described herein, may be any combination of hardware and programming to implement the functionalities of the respective modules. In some examples described herein, the combinations of hardware and programming may be implemented in a number of different ways. For example, the programming for the modules may be processor executable instructions stored on a non-transitory machine-readable storage medium and the hardware for the modules may include a processing resource to execute those instructions. In these examples, a computing device implementing such modules may include the machine-readable storage medium storing the instructions and the processing resource to execute the instructions, or the machine-readable storage medium may be separately stored and accessible by the computing device and the processing resource. In some examples, some modules may be implemented in circuitry.

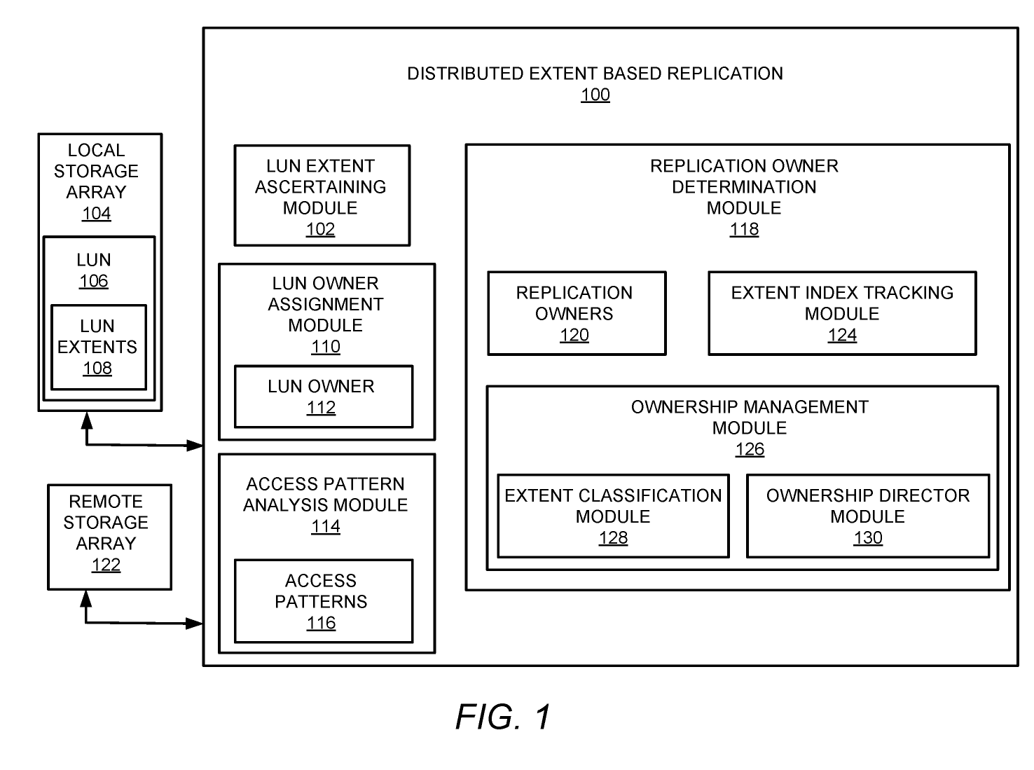

FIG. 1 illustrates an example layout of a distributed extent based replication apparatus (hereinafter also referred to as “apparatus 100”).

Referring to FIG. 1, the apparatus 100 may include a LUN extent ascertaining module 102 to ascertain (e.g., by identifying), for a local storage array 104 comprising a LUN 106, a plurality of LUN extents 108. According to examples, a LUN extent of the plurality of LUN extents 108 may represent a range of contiguous logical block addresses (LBAs) on the LUN 106.

A LUN owner assignment module 110 may assign a LUN owner 112 to the LUN 106.

An access pattern analysis module 114 may analyze respective access patterns 116 used to access each of the plurality of LUN extents 108.

A replication owner determination module 118 may determine, based on the analyzed access patterns 116, respective replication owners 120 for each of the plurality of LUN extents 108 independent of the LUN owner 112 assigned to the LUN 106. The replication owners 120 may be described as the entities (e.g., respective different storage arrays, respective associated hosts, etc.) that are assigned replication ownership rights, and thus the replication direction, with respect to each of the plurality of LUN extents 108.

According to examples, the replication owner determination module 118 may determine, based on the analyzed access patterns 116, respective replication owners 120 for each of the plurality of LUN extents 108 independent of the LUN owner 112 assigned to the LUN 106 by identifying, for each LUN extent of the plurality of LUN extents 108, whether accesses to the LUN extent are from the local storage array 104 exclusively, are from a remote storage array 122 exclusively, or are from both the local storage array 104 and the remote storage array 122 (e.g., are mixed). The remote storage array 122 may be different from the local storage array 104. For example, the replication owner determination module 118 may identify, for each LUN extent of the plurality of LUN extents 108, whether write accesses to the LUN extent for a specified time duration are from the local storage array 104 exclusively, are from a remote storage array 122 exclusively, or are from both the local storage array 104 and the remote storage array 122 (e.g., are mixed).

According to examples, for a given LUN extent of the plurality of LUN extents 108, based on an identification that the accesses to the given LUN extent are from the local storage array 104 exclusively, the replication owner determination module 118 may determine that the local storage array 104 is a replication owner (e.g., one of the replication owners 120) for the given LUN extent.

According to examples, for a given LUN extent of the plurality of LUN extents 108, based on an identification that the accesses to the given LUN extent are from the remote storage array 122 exclusively, the replication owner determination module 118 may determine that the remote storage array 122 is a replication owner (e.g., one of the replication owners 120) for the given LUN extent.

According to examples, for a given LUN extent of the plurality of LUN extents 108, based on an identification that the accesses to the given LUN extent are from both the local storage array 104 and the remote storage array 122 (e.g., are mixed), the replication owner determination module 118 may determine whether a number of the accesses to the given LUN extent from the local storage array 104 is greater than a number of the accesses to the given LUN extent from the remote storage array 122. Further, based on a determination that the number of the accesses to the given LUN extent from the local storage array 104 is greater than the number of the accesses to the given LUN extent from the remote storage array 122, the replication owner determination module 118 may determine that the local storage array 104 is a replication owner (e.g., one of the replication owners 120) for the given LUN extent.

According to examples, for a given LUN extent of the plurality of LUN extents 108, based on an identification that the accesses to the given LUN extent are from both the local storage array 104 and the remote storage array 122, the replication owner determination module 118 may determine whether a number of the accesses from the remote storage array 122 is greater than a number of the accesses from the local storage array 104 by a given factor. Based on a determination that the number of the accesses from the remote storage array 122 is greater than the number of the accesses from the local storage array 104 by the given factor, the replication owner determination module 118 may determine that the remote storage array 122 is a replication owner (e.g., one of the replication owners 120) for the given LUN extent.

According to examples, the given factor may be greater than one. For example, the given factor may be two (e.g., where a number of the accesses from the remote storage array 122 is twice the number of the accesses from the local storage array 104).

According to examples, the replication owner determination module 118 may determine, based on the analyzed access patterns 116, a first replication owner for a LUN extent of the plurality of LUN extents 108. Further, the replication owner determination module 118 may determine, based on the analyzed access patterns 116, a second replication owner that is different from the first replication owner for another LUN extent of the plurality of LUN extents 108. In this manner, the replication owner determination module 118 may determine the same or different replication owners for each of the plurality of LUN extents 108.

According to examples, the replication owner determination module 118 may determine, based on the analyzed access patterns 116, whether a given LUN extent of the plurality of LUN extents 108 is to be replicated. For example, if the access patterns 116 indicate that there are no accesses from the local storage array 104 or the remote storage array 122, then the replication owner determination module 118 may determine, based on the analyzed access patterns 116, that the given LUN extent of the plurality of LUN extents 108 is to not be replicated.

Operation of the apparatus 100 is described in further detail with reference to FIGS. 1-6.

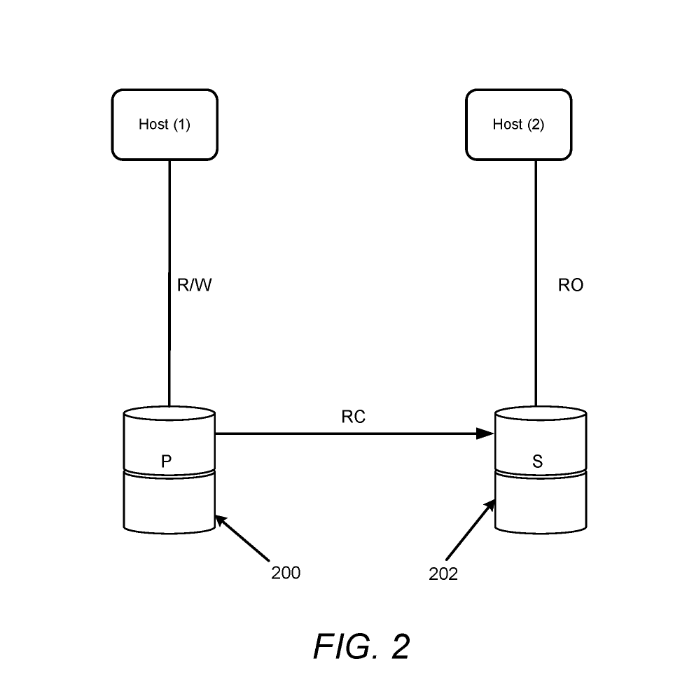

FIG. 2 illustrates unidirectional LUN access to illustrate operation of the apparatus 100.

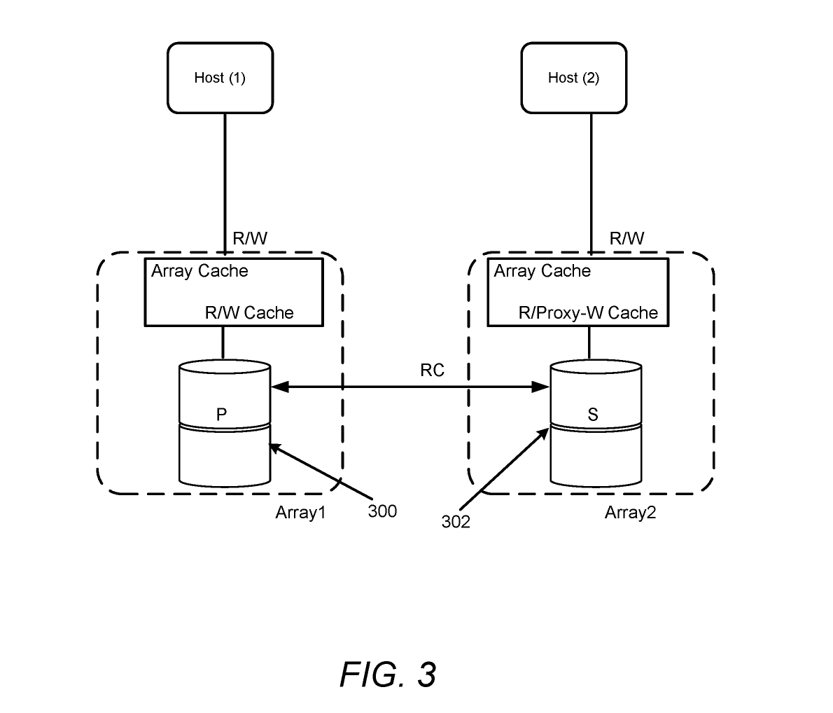

Referring to FIG. 2, a unidirectional remote copy (RC) Sync replication between a primary storage array 200 and secondary storage array 202 may include one array (e.g., the primary array designated as “P”) that services all reads and writes, and then replicates all the writes to the other array (e.g., the secondary array designated as “S”) before acknowledging the host writes. The primary LUN at the primary storage array 200 in Read/Write mode may be designated as a source LUN. The secondary LUN at the secondary storage array 202 with Read-Only mode may be designated as a remote copy target LUN. The primary and secondary arrays may offer both types of LUNs (e.g., primary and secondary) with an independent set of LUNs. For the apparatus 100, as disclosed herein with respect to FIGS. 3-6, the aspects of “Primary” and “Secondary” may be maintained, however with different granularity. That is, the new granularity may be based on the LUN extents 108 that may be managed independently with respect to replication ownership.

FIG. 3 illustrates example bidirectional LUN access with smart proxy to illustrate operation of the distributed extent based replication apparatus of FIG. 1.

Referring to FIG. 3, the bidirectional LUN access with smart proxy may provide an active-active replication and input/output (I/O) fencing. In this regard, the I/O fencing may remain unchanged as a new technique for achieving active-active replication between two storage arrays, and may also be utilized unchanged in conjunction with extent based replication as disclosed herein.

With respect to FIG. 3, the bidirectional access technologies may enable a primary storage array 300 and a secondary storage array 302 to receive and process host writes as active targets. The secondary storage array 302 may be allowed to receive write I/O′s with an associated secondary LUN as an active target, but the primary storage array 300 may maintain ownership and control over I/O ordering for the primary storage array 300 and the secondary storage array 302 such that all writes to the secondary LUN are led by writes to the primary LUN associated with the primary storage array 300. When the secondary storage array 302 receives a write I/O directed to the secondary LUN, the secondary storage array 302 may send a copy of the write to the primary storage array 300 via a replication channel while also holding the write in a fenced portion of its own cache. The term fenced may be used to mean that the data is not treated as written yet, and the data is not allowed to be processed by any normal cache management processes. For example, fenced writes cannot be read by other hosts, written to disk, etc., until they are released. The secondary storage array 302 may wait to release the write until a write acknowledgement is received from the primary storage array 300. Releasing the write may mean admitting the write to the cache, which may include, for example, unfencing the portion of the cache that holds the write and allocating it to the secondary LUN, or moving the write to another portion of the cache that is unfenced and allocated to the secondary LUN.

Further, as soon as the secondary storage array 302 receives the acknowledgement from the primary storage array 300, the secondary storage array 302 may release the fencing of the host write, respond back to the host, and send the write to its own backend to process. Thus, although the secondary storage array 302 is able to receive and process writes from hosts targeting the secondary LUN, the primary storage array 300 may still lead the writes because the secondary storage array 302 does not commit the writes until and unless the primary storage array 300 has acknowledged back to the secondary storage array 302. From the perspective of a host, however, both the primary LUN and the secondary LUN may be active targets for receiving both read and write I/O.

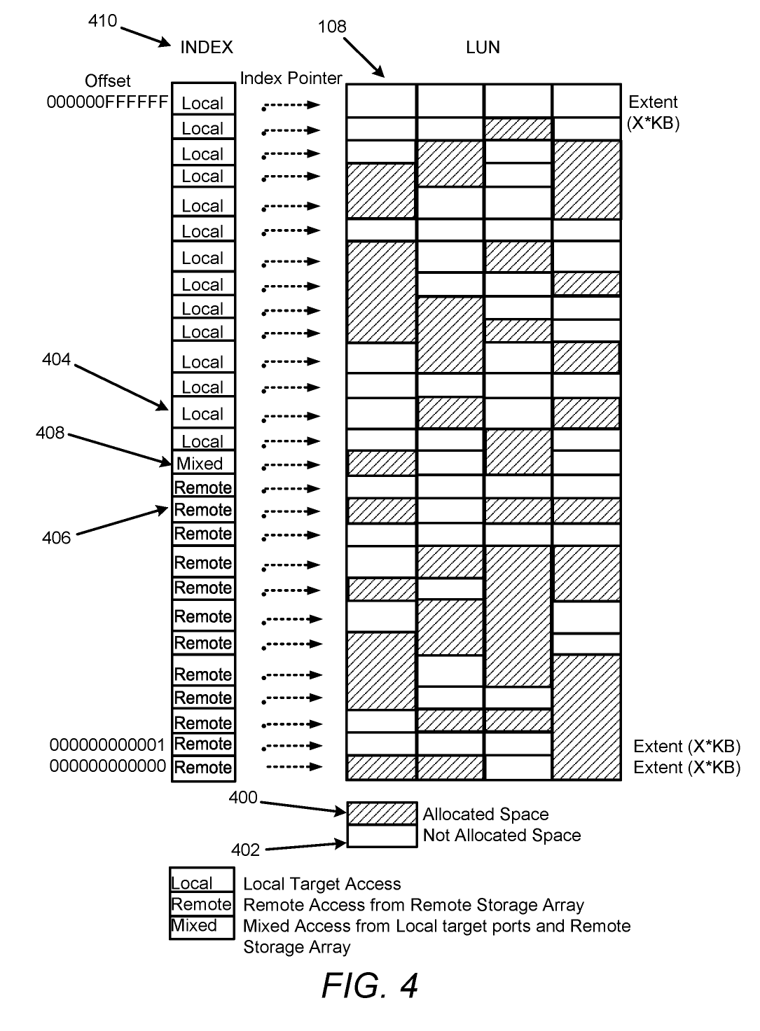

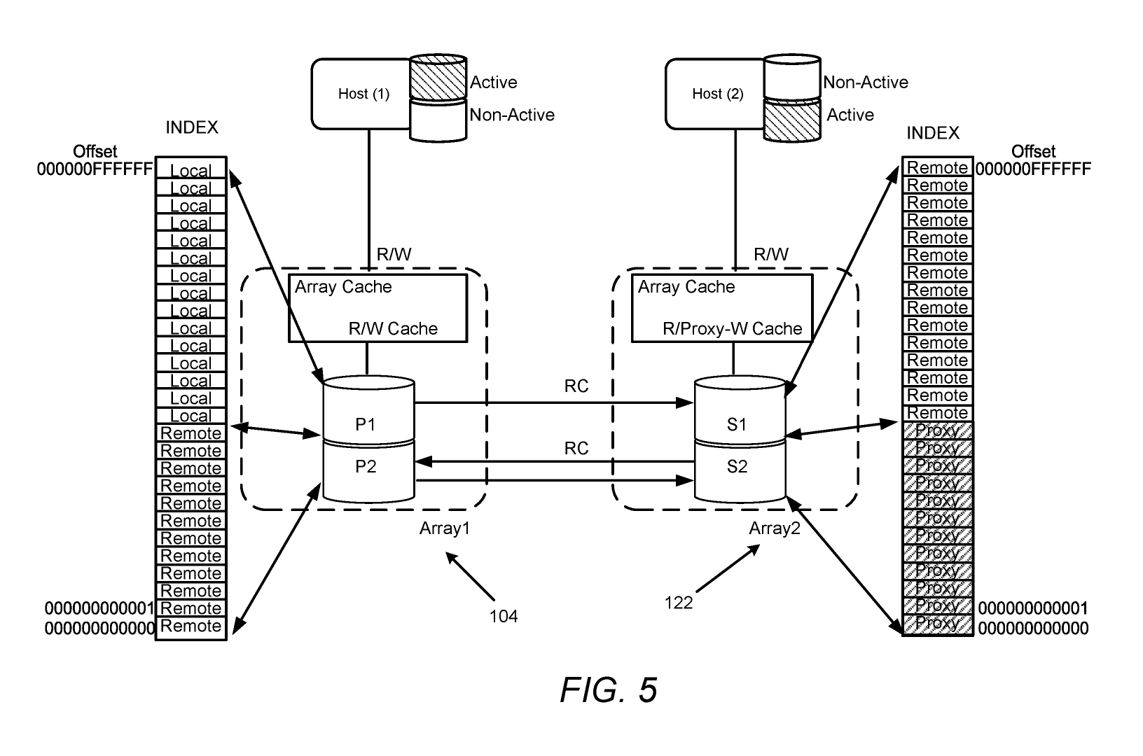

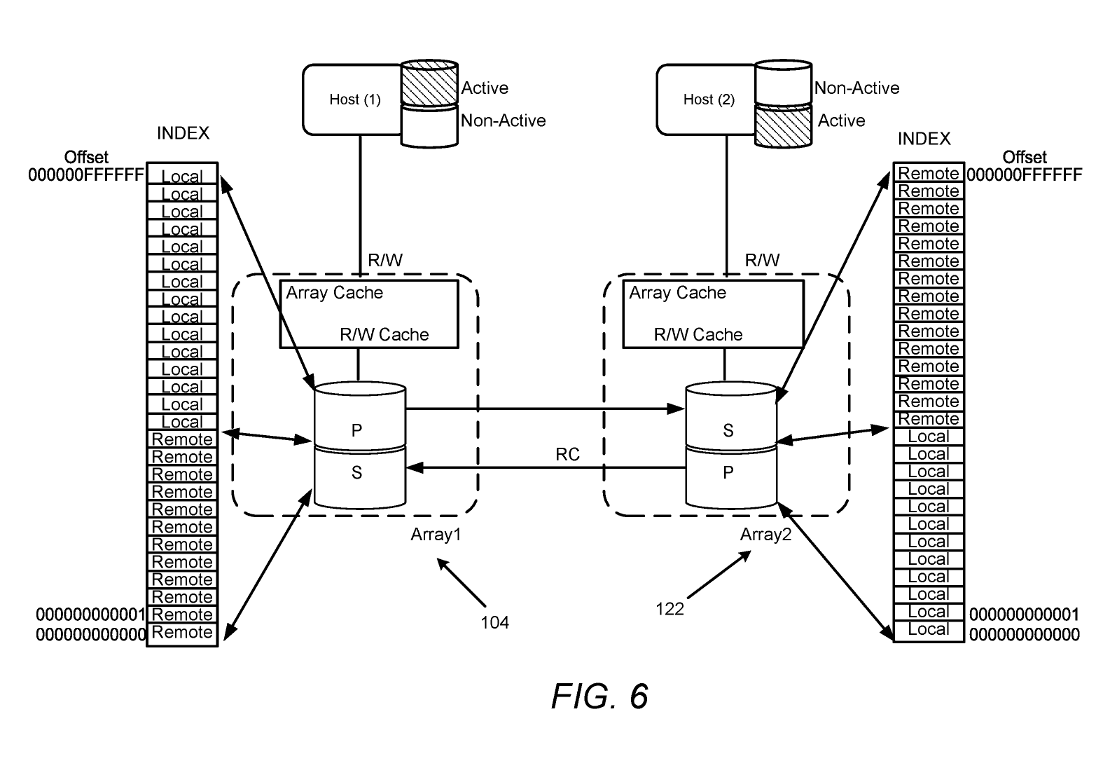

FIG. 4 illustrates an example LUN including a plurality of LUN extents 108 to illustrate operation of the apparatus 100. FIG. 5 illustrates example bidirectional LUN access for a fully replicated LUN to illustrate operation of the apparatus 100. Further, FIG. 6 illustrates example bidirectional LUN access replication to illustrate operation of the apparatus 100.

With respect to extent based replication as disclosed herein with respect to FIGS. 1 and 4-6, LUNs may be replicated between arrays in one-to-one or one-to-many relationships in synchronous or asynchronous modes. The access may also be unidirectional as disclosed herein with respect to FIG. 2, or bidirectional in active-active as disclosed herein with respect to FIG. 3.

A host may access a LUN in Read/Write from a remote storage array (such as the remote storage array 122) in “reverse access” rather than a local storage array (such as the local storage array 104) while replicating back to the local storage array. The reverse access may be for the entire LUN, or for parts of the LUNs in active-active setups as disclosed herein with respect to FIG. 3. The reverse access may also be prevalent in synchronous and asynchronous replication. The reverse access may result in performance degradation with respect to the synchronous and asynchronous replication, as well as for active-active replication.

The performance degradation associated with this reverse access may be addressed by the extent based replication as disclosed herein by further decoupling the LUN replication ownership and direction from the LUN itself, and associating the replication with the LUN extents 108 as illustrated in FIG. 4. In this regard, the extent based replication may allow the storage array and/or host layers control over the LUN extents replication direction. The extent based replication may determine remote copy replication direction based on the LUN extents 108, instead of the replication being uniform for the entire LUN.

With respect to the LUN extents 108, referring to FIG. 4, a plurality of the LUN extents 108 are illustrated. The cross-sections at 400 may represent allocated spaces for the LUN extents 108, and the blank spaces at 402 may represent non-allocated spaces. The identifications at 404, 406, and 408 may respectively represent accesses to the LUN extent from the local storage array 104 exclusively, from the remote storage array 122 exclusively, or from both the local storage array 104 and the remote storage array 122 (e.g., mixed). A LUN extent size may be fixable, and may be based on the specific storage array implementation where a LUN extent may be as small as few kilobytes, and as large as the entire LUN. Each storage array may include a predetermined minimum extent size. Further, each storage array may manage the LUN(s) in multiples of those LUN extents 108 which may include the entire LUN logical block addresses (LBA) range.

With respect to extent based replication, a storage array may offer replication direction and host access to a LUN extent based on storage array internal access detection for access locality. In this regard, the access may be identified by a storage array (or a plurality of storage arrays) that is part of a replication group or pair (e.g., the pair of storage arrays of FIGS. 5 and 6). Alternatively or additionally, a storage array may offer replication direction and host access to a LUN extent based on an external software trigger that may be integrated, for example, with a service level objective (SLO) engine, a user interface, a host application, a host operating system agent, etc.

Referring to FIGS. 1 and 4, an addressable LUN extent may include a LUN extent index 410 that is determined by an extent index tracking module 124, and further utilized by an ownership management module 126 of the replication owner determination module 118. The LUN extent index 410 may include an index of the identifications at 404, 406, and 408 that, as disclosed herein, may respectively represent accesses (i.e., access patterns) to the LUN extent from the local storage array 104 exclusively, from the remote storage array 122 exclusively, or from both the local storage array 104 and the remote storage array 122 (e.g., mixed). The extent index tracking module 124 and ownership management module 126 may provide for the management of the LUN extent ownership and replication direction.

With respect to the extent index tracking module 124, an actively accessed LUN 106 may be managed as a range of logical block addresses or a set of the LUN extents 108 (or a single LUN extent). The extent index tracking module 124 may classify the write inputs/outputs by mapping, classifying, and counting each write input/output that targets each LUN extent. The write inputs/outputs may be received from various sources and classified as remote input/output access, and non-remote input/output access. For the remote input/output access, the write inputs/outputs may be received, for example, at remote copy replication ports. For the non-remote input/output access, the write inputs/outputs may be received, for example, at target ports from a host facing interconnect such as fiber channel (FC), internet small computer systems interface (iSCSI), fiber channel over Ethernet (FCoE), Internet Protocol (IP), etc. For the non-remote input/output access, the write inputs/outputs may be received, for example, from an internal replication or internal copy engine, or a function. As shown in FIGS. 5 and 6, each LUN extent may be mapped to the local storage array 104, the remote storage array 122, or to mixed sources (e.g., both the local storage array 104 and the remote storage array 122), but may also be mapped to the remote versus the non-remote input/output access categories. Each LUN extent may also be independently tracked by each storage array if needed.

As disclosed herein, the replication owner determination module 118 may determine, based on the analyzed access patterns 116, respective replication owners 120 for each of the plurality of LUN extents 108 independent of the LUN owner 112 assigned to the LUN 106. In this regard, based on the LUN extent access types of local and/or remote (e.g., whether accesses to the LUN extent are from the local storage array 104, are from the remote storage array 122, or are both from the local storage array 104 and the remote storage array 122) each LUN extent may include a weighed access pattern that may be tracked by an associated storage array.

Within a non-replicated or replicated volume, a LUN extent (or a range of LUN extents) may include one of three distinct write states associated therewith. These write states may be ascertained by monitoring each LUN extent within a given period of time interval. The LUN extent state may be ascertained to identify a LUN extent's write state by the extent index tracking module 124. As disclosed herein, the three write states may include a local access state associated with the local storage array 104, a remote access state associated with the remote storage array 122, and a mixed access state that includes access from both the local storage array 104 and the remote storage array 122.

With respect to the local access state associated with the local storage array 104, the local access state may denote a host local access through the storage array target ports (e.g., for a LUN extent at the local storage array 104). The remote access state associated with the remote storage array 122 may denote remote access through a storage array's remote copy ports (e.g., for a LUN extent at the remote storage array 122, and may be through remote copy replication write traffic, or proxied write host access from another active-active storage array). Further, the mixed access state that includes access from both the local storage array 104 and the remote storage array 122 may denote a LUN extent that has mixed local, remote, or proxy access (e.g., for a LUN extent at the remote storage array 122).

With respect to the mixed access state that includes access from both the local storage array 104 and the remote storage array 122, as disclosed herein, based on an identification that the accesses to the LUN extent are from both the local storage array 104 and the remote storage array 122 (e.g., are mixed), the replication owner determination module 118 may determine whether a number of the accesses to the LUN extent from the local storage array 104 is greater than a number of the accesses to the LUN extent from the remote storage array 122. For example, if a LUN extent includes mixed access that is divided between two storage arrays (or more), the replication owner determination module 118 may determine the replication ownership of the mixed access LUN extent with respect to rules/policies associated with the LUN owner 112 array.

The LUN owner 112 array may track an access ratio in a predefined tracking period between local and remote access. According to an example, the access ratio may be specified as 1:2 (e.g., where the given factor is equal to two as disclosed herein). For example, if one access type is twice the other, then the greater access rate may decide the ownership of the mixed LUN extent. In this regard, the given factor may be any number greater than one (e.g., 1.1, 1.5, 2, 4, 10, etc.), or vise-versa, less than one. Alternatively, the access relationship between the local storage array and the remote storage array for mixed access may be determined based on a function, or another technique. Based on the decision, the replication ownership may either stay, or may fail-over to the remote storage array for increased performance.

A mixed access LUN extent may be defined by local access versus remote access. Thus, such a mixed access LUN extent may be in mixed access mode for a relatively long time period. Further, such a mixed access LUN extent may be managed on either storage array (e.g., local or remote) based on its access ratio via local and remote proxied access.

The mixed access state may likely occur when the LUN extent defined by the storage array implementation may be relatively large in size, and include overlapping access from local target ports and remote ports.

The ownership management module 126 of the replication owner determination module 118 may include an extent classification module 128 and an ownership director module 130.

With respect to FIG. 4, the extent classification module 128 may identify the local, remote and mixed access LUN extents based on the host access pattern. The extent classification module 128 may identify the local, remote and mixed access LUN extents periodically based on a predetermined scan cycle. The period of the scan cycle may be defined by array defaults, or may otherwise be user-specified. A classification scan job may also be triggered, for example, via a command-line interface (CLI) command, a script, etc., after host access shifts from one storage array to another storage array. Alternatively or additionally, the classification scan job may be triggered by a host workload rebalance integration layer from one host/data-center to the another, or based on host failover policies. The extent classification module 128 may further implement policies, such as the ratio driven logic (e.g., the given factor as disclosed herein), for mixed LUN extents.

With respect to FIGS. 5 and 6, the ownership director module 130 may identify the final replication ownership state (e.g., one of the replication owners 120) of a LUN extent. The ownership director module 130 may receive inputs in the form of an internal extent classifier service or an external extent classifier service from the extent classification module 128. For example, an input may include the LUN extent index 410. With respect to the internal extent classifier service, this classification may be performed internally based on the LUN extent access being local, remote, or mixed access. With respect to the external extent classifier service, this classification may be driven by an external classification criteria, a desired failover policy, performance anticipation, and/or by host and/or user requests.

The ownership director module 130 may change (or schedule) the replication ownership of a LUN extent from one storage array to another storage array to re-assign local write access. This ownership change may eliminate the need for an input/output proxy process, hence facilitating LUN extent access for the bidirectional remote replication with the smart proxy use case. With the LUN extent replication ownership changes, the LUN extent replication direction may change from one storage array to another storage array (e.g., between the primary and secondary storage arrays of FIGS. 5 and 6). For example, for FIG. 5, primary partition P1 of the local storage array 104 may include local access and primary partition P2 of the local storage array 104 may include remote access. Similarly, secondary partition S1 of the remote storage array 122 may include remote access and secondary partition S2 of the remote storage array 122 may include proxy access. In this regard, the local storage array 104 and the remote storage array 122 may include remote copy access from partition P1 to partition 51. Further, the local storage array 104 and the remote storage array 122 may include remote copy access from partition P2 to partition S2. Similarly, for FIG. 6, primary partition P of the local storage array 104 may include local access and secondary partition S of the local storage array 104 may include remote access. For FIG. 6, secondary partition S of the remote storage array 122 may include remote access and primary partition P of the remote storage array 122 may include local access. In this regard, the local storage array 104 and the remote storage array 122 may include remote copy access from upper partition P (in the orientation of FIG. 6) to upper partition S. Further, the local storage array 104 and the remote storage array 122 may include remote copy access from lower partition P (in the orientation of FIG. 6) to lower partition S. In this manner, a LUN extent may be classified and reclassified periodically based on the changes in the host access patters, followed by a replication ownership change to ensure optimal performance. The LUN extent replication ownership changes may also be scheduled over a period of time on a per LUN or LUN group basis.

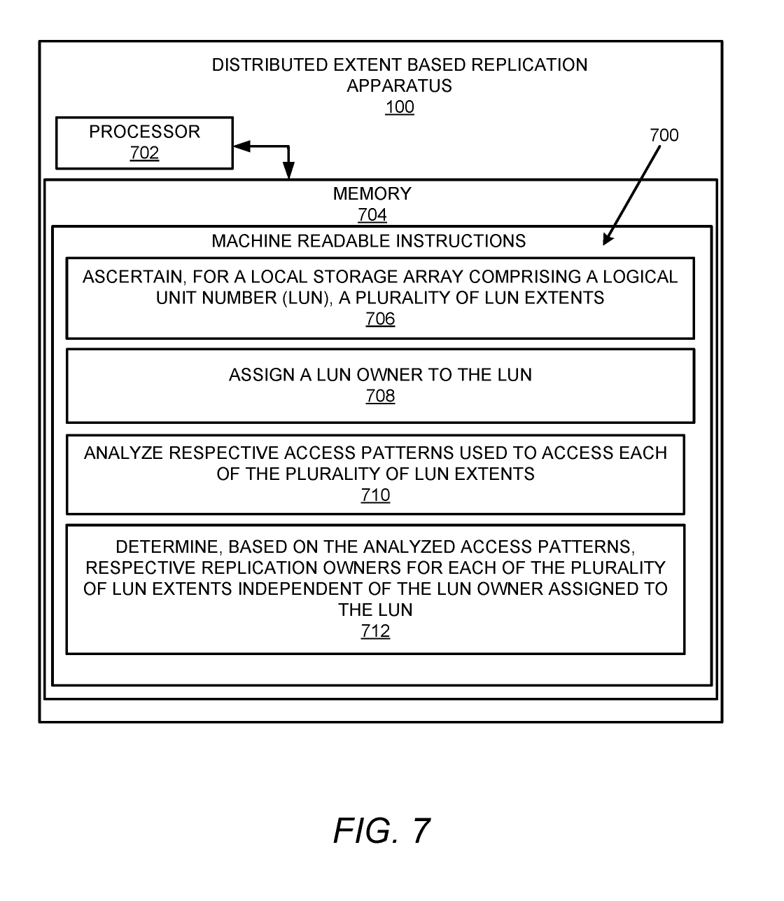

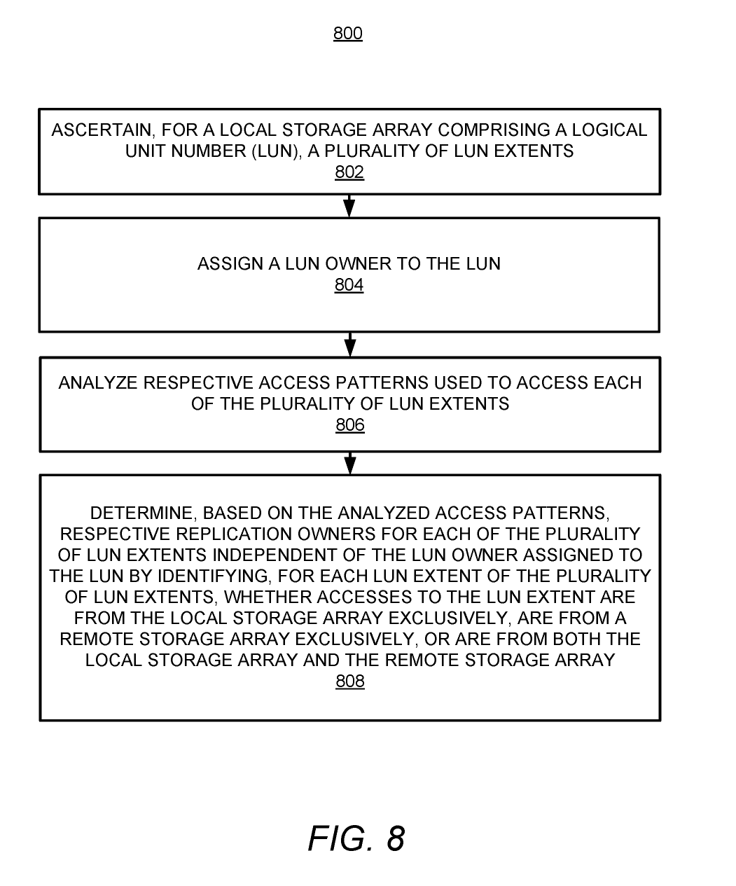

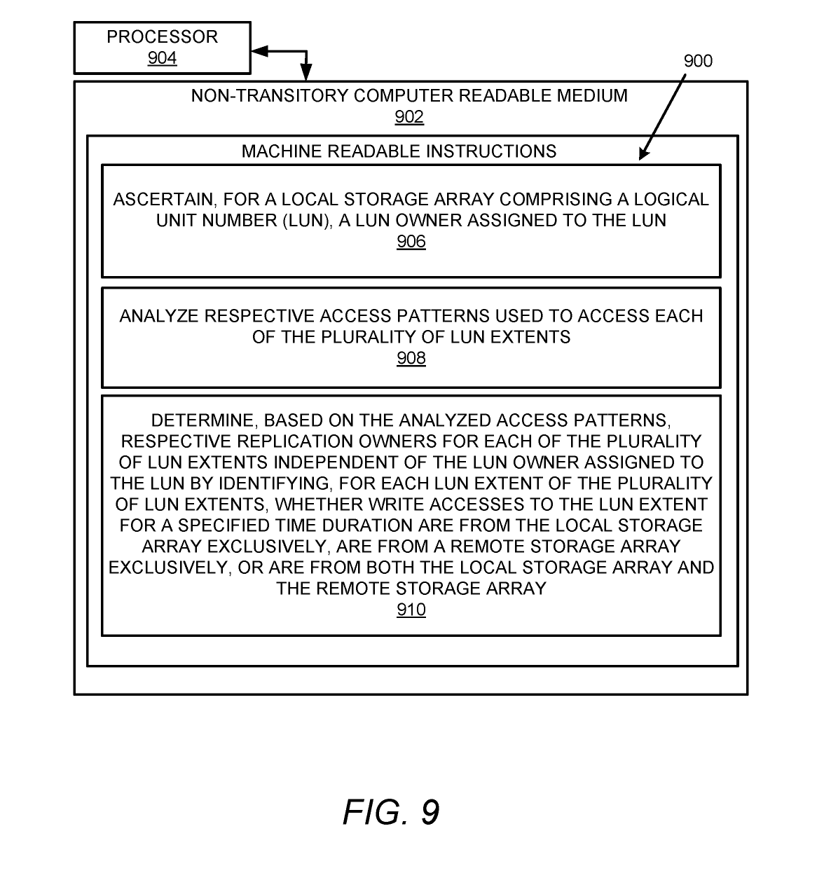

FIGS. 7-9 respectively illustrate an example block diagram 700, an example flowchart of a method 800, and a further example block diagram 900 for distributed extent based replication. The block diagram 700, the method 800, and the block diagram 900 may be implemented on the apparatus 100 described above with reference to FIG. 1 by way of example and not limitation. The block diagram 700, the method 800, and the block diagram 900 may be practiced in other apparatus. In addition to showing the block diagram 700, FIG. 7 shows hardware of the apparatus 100 that may execute the instructions of the block diagram 700. The hardware may include a processor 702, and a memory 704 (i.e., a non-transitory computer readable medium) storing machine readable instructions that when executed by the processor cause the processor to perform the instructions of the block diagram 700. The memory 704 may represent a non-transitory computer readable medium. FIG. 8 may represent a method for distributed extent based replication, and the steps of the method. FIG. 9 may represent a non-transitory computer readable medium 902 having stored thereon machine readable instructions to provide distributed extent based replication. The machine readable instructions, when executed, cause a processor 904 to perform the instructions of the block diagram 900 also shown in FIG. 9.

The processor 702 of FIG. 7 and/or the processor 904 of FIG. 9 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 902 of FIG. 9), such as hardware storage devices (e.g., RAM (random access memory), ROM (read only memory), EPROM (erasable, programmable ROM), EEPROM (electrically erasable, programmable ROM), hard drives, and flash memory). The memory 704 may include a RAM, where the machine readable instructions and data for a processor may reside during runtime.

Referring to FIGS. 1-7, and particularly to the block diagram 700 shown in FIG. 7, the memory 704 may include instructions 706 to ascertain, for a local storage array 104 comprising a LUN 106, a plurality of LUN extents 108.

The processor 702 may fetch, decode, and execute the instructions 708 to assign a LUN owner 112 to the LUN 106.

The processor 702 may fetch, decode, and execute the instructions 710 to analyze respective access patterns 116 used to access each of the plurality of LUN extents 108.

The processor 702 may fetch, decode, and execute the instructions 712 to determine, based on the analyzed access patterns 116, respective replication owners 120 for each of the plurality of LUN extents 108 independent of the LUN owner 112 assigned to the LUN 106.

Referring to FIGS. 1-6 and 8, and particularly FIG. 8, for the method 800, at block 802, the method may include ascertaining, for a local storage array 104 comprising a LUN 106, a plurality of LUN extents 108.

At block 804 the method may include assigning a LUN owner 112 to the LUN 106.

At block 806 the method may include analyzing respective access patterns 116 used to access each of the plurality of LUN extents 108.

At block 808 the method may include determining, based on the analyzed access patterns 116, respective replication owners 120 for each of the plurality of LUN extents 108 independent of the LUN owner 112 assigned to the LUN 106 by identifying, for each LUN extent of the plurality of LUN extents 108, whether accesses to the LUN extent are from the local storage array 104 exclusively, are from a remote storage array 122 exclusively, or are from both the local storage array 104 and the remote storage array 122, where the remote storage array 122 may be different from the local storage array 104.

Referring to FIGS. 1-6 and 9, and particularly FIG. 9, for the block diagram 900, the non-transitory computer readable medium 902 may include instructions 906 to ascertain, for a local storage array 104 comprising a LUN 106, a LUN owner 112 assigned to the LUN 106, wherein the LUN 106 may include a plurality of LUN extents 108.

The processor 904 may fetch, decode, and execute the instructions 908 to analyze respective access patterns 116 used to access each of the plurality of LUN extents 108.

The processor 904 may fetch, decode, and execute the instructions 910 to determine, based on the analyzed access patterns 116, respective replication owners 120 for each of the plurality of LUN extents 108 independent of the LUN owner 112 assigned to the LUN 106 by identifying, for each LUN extent of the plurality of LUN extents 108, whether write accesses to the LUN extent for a specified time duration are from the local storage array 104 exclusively, are from a remote storage array 122 exclusively, or are from both the local storage array 104 and the remote storage array 122, where the remote storage array 122 may be different from the local storage array 104.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium storing machine readable instructions that when executed by the processor cause the processor to:
ascertain, for a local storage array comprising a logical unit number (LUN), a plurality of LUN extents;
assign a LUN owner to the LUN;
analyze respective access patterns used to access each of the plurality of LUN extents; and
determine, based on the analyzed access patterns, respective replication owners for each of the plurality of LUN extents independent of the LUN owner assigned to the LUN.

2. The apparatus according to claim 1, wherein a LUN extent of the plurality of LUN extents represents a range of contiguous logical block addresses (LBAs) on the LUN.

3. The apparatus according to claim 1, wherein the instructions to determine are further to cause the processor to:
identify, for each LUN extent of the plurality of LUN extents, whether accesses to the LUN extent are from the local storage array exclusively, are from a remote storage array exclusively, or are from both the local storage array and the remote storage array, wherein the remote storage array is different from the local storage array.

4. The apparatus according to claim 3, wherein the instructions to identify are further to cause the processor to:
for a given LUN extent of the plurality of LUN extents, based on an identification that the accesses to the given LUN extent are from the local storage array exclusively, determine that the local storage array is a replication owner for the given LUN extent.

5. The apparatus according to claim 3, wherein the instructions to identify are further to cause the processor to:
for a given LUN extent of the plurality of LUN extents, based on an identification that the accesses to the given LUN extent are from the remote storage array exclusively, determine that the remote storage array is a replication owner for the given LUN extent.

6. The apparatus according to claim 3, wherein the instructions to identify are further to cause the processor to:
for a given LUN extent of the plurality of LUN extents, based on an identification that the accesses to the given LUN extent are from both the local storage array and the remote storage array, determine whether a number of the accesses to the given LUN extent from the local storage array is greater than a number of the accesses to the given LUN extent from the remote storage array; and
based on a determination that the number of the accesses to the given LUN extent from the local storage array is greater than the number of the accesses to the given LUN extent from the remote storage array, determine that the local storage array is a replication owner for the given LUN extent.

7. The apparatus according to claim 3, wherein the instructions to identify are further to cause the processor to:
for a given LUN extent of the plurality of LUN extents, based on an identification that the accesses to the given LUN extent are from both the local storage array and the remote storage array, determine whether a number of the accesses from the remote storage array is greater than a number of the accesses from the local storage array by a given factor; and
based on a determination that the number of the accesses from the remote storage array is greater than the number of the accesses from the local storage array by the given factor, determine that the remote storage array is a replication owner for the given LUN extent.

8. The apparatus according to claim 7, wherein the given factor is greater than one.

9. The apparatus according to claim 1, wherein the instructions to determine are further to cause the processor to:
determine, based on the analyzed access patterns, a first replication owner for a LUN extent of the plurality of LUN extents; and
determine, based on the analyzed access patterns, a second replication owner that is different from the first replication owner for another LUN extent of the plurality of LUN extents.

10. The apparatus according to claim 1, wherein the instructions to determine are further to cause the processor to:
determine, based on the analyzed access patterns, whether a given LUN extent of the plurality of LUN extents is to be replicated.

11. A computer implemented method comprising:
ascertaining, for a local storage array comprising a logical unit number (LUN), a plurality of LUN extents;
assigning a LUN owner to the LUN;
analyzing respective access patterns used to access each of the plurality of LUN extents; and
determining, based on the analyzed access patterns, respective replication owners for each of the plurality of LUN extents independent of the LUN owner assigned to the LUN by identifying, for each LUN extent of the plurality of LUN extents, whether accesses to the LUN extent are from the local storage array exclusively, are from a remote storage array exclusively, or are from both the local storage array and the remote storage array, wherein the remote storage array is different from the local storage array.

12. The method according to claim 11, wherein the LUN extent represents a range of contiguous logical block addresses (LBAs) on the LUN.

13. The method according to claim 11, wherein identifying further comprises:
for a given LUN extent of the plurality of LUN extents, based on an identification that the accesses to the given LUN extent are from the local storage array exclusively, determining that the local storage array is a replication owner for the given LUN extent.

14. The method according to claim 11, wherein identifying further comprises:
for a given LUN extent of the plurality of LUN extents, based on an identification that the accesses to the given LUN extent are from the remote storage array exclusively, determining that the remote storage array is a replication owner for the given LUN extent.

15. The method according to claim 11, wherein identifying further comprises:
for a given LUN extent of the plurality of LUN extents, based on an identification that the accesses to the given LUN extent are from both the local storage array and the remote storage array, determining whether a number of the accesses to the given LUN extent from the local storage array is greater than a number of the accesses to the given LUN extent from the remote storage array; and
based on a determination that the number of the accesses to the given LUN extent from the local storage array is greater than the number of the accesses to the given LUN extent from the remote storage array, determining that the local storage array is a replication owner for the given LUN extent.

16. A non-transitory computer readable medium having stored thereon machine readable instructions, the machine readable instructions, when executed, cause a processor to:
ascertain, for a local storage array comprising a logical unit number (LUN), a LUN owner assigned to the LUN, wherein the LUN comprises a plurality of LUN extents;
analyze respective access patterns used to access each of the plurality of LUN extents; and
determine, based on the analyzed access patterns, respective replication owners for each of the plurality of LUN extents independent of the LUN owner assigned to the LUN by identifying, for each LUN extent of the plurality of LUN extents, whether write accesses to the LUN extent for a specified time duration are from the local storage array exclusively, are from a remote storage array exclusively, or are from both the local storage array and the remote storage array, wherein the remote storage array is different from the local storage array.

17. The non-transitory computer readable medium according to claim 16, wherein the machine readable instructions to identify, when executed, further cause the processor to:
for a given LUN extent of the plurality of LUN extents, based on an identification that the write accesses to the given LUN extent for the specified time duration are from the remote storage array exclusively, determine that the remote storage array is a replication owner for the given LUN extent.

18. The non-transitory computer readable medium according to claim 16, wherein the machine readable instructions to identify, when executed, further cause the processor to:
for a given LUN extent of the plurality of LUN extents, based on an identification that the write accesses to the given LUN extent for the specified time duration are from both the local storage array and the remote storage array, determine whether a number of the write accesses from the remote storage array is greater than a number of the write accesses from the local storage array by a given factor; and
based on a determination that the number of the write accesses from the remote storage array is greater than the number of the write accesses from the local storage array by the given factor, determine that the remote storage array is a replication owner for the given LUN extent.

19. The non-transitory computer readable medium according to claim 18, wherein the given factor is greater than one.

20. The non-transitory computer readable medium according to claim 16, wherein the machine readable instructions to determine, when executed, further cause the processor to:
determine, based on the analyzed access patterns, a first replication owner for a LUN extent of the plurality of LUN extents; and
determine, based on the analyzed access patterns, a second replication owner that is different from the first replication owner for another LUN extent of the plurality of LUN extents.
